(19) United States
(12) Patent Application Publication
(10) Pub. No.: US 2012/0288100 A1
(43) Pub. Date: Nov. 15, 2012

(54) METHOD AND APPARATUS FOR PROCESSING MULTI-CHANNEL DE-CORRELATION FOR CANCELLING MULTI-CHANNEL ACOUSTIC ECHO

(75) Inventor: Nam-gook CHO, Suwon-si (KR)

(73) Assignee: SAMSUNG ELECTRONICS CO., LTD., Suwon-si (KR)

(21) Appl. No.: 13/469,924

(22) Filed: May 11, 2012

Related U.S. Application Data
(60) Provisional application No. 61/484,738, filed on May 11, 2011.

(30) Foreign Application Priority Data
Mar. 7, 2012 (KR) 10-2012-0023604

(51) Int. Cl. H04R 5/00

(52) U.S. Cl. 381/22

(57) ABSTRACT

Provided are a method and apparatus for multi-channel de-correlation processing for cancelling a multi-channel acoustic echo. The method includes: dividing an input multi-channel audio signal into units of frames to form multi-channel audio signals in units of frames; analyzing eigen values and eigen vectors related to the multi-channel audio signals by using the multi-channel audio signals in units of frames every time contents are modified; and separating the multi-channel audio signals in units of frames into a plurality of signal component spaces by using the analyzed eigen values and eigen vectors.

### CROSS-REFERENCE TO RELATED PATENT APPLICATION

This application claims priority from Korean Patent Application No. 10-2012-0023604, filed on Mar. 7, 2012 in the Korean Intellectual Property Office, and U.S. Provisional Application No. 61/484,738 filed on May 11, 2011 in U.S. Patent and Trademark Office, the disclosures of which are incorporated herein in their entireties by reference.

### BACKGROUND OF THE INVENTION

1. Field of the Invention

Methods and apparatuses consistent with exemplary embodiments relate to cancelling a multi-channel acoustic echo, and more particularly, to processing multi-channel de-correlation for cancelling a multi-channel acoustic echo.

2. Description of the Related Art

Voice recognition technology for controlling various machines by using a voice signal is in development. Voice recognition technology is a technology involving inputting a voice signal by using a hardware or software apparatus, recognizing the linguistic meaning of the voice signal, and performing an operation according to the meaning of the voice signal.

Multi-channel acoustic echo cancellation (MASC) technology is widely used in video phone calling systems and voice recognition systems in which microphones and loudspeakers are used.

In general, a signal output from a loudspeaker of a video phone calling system or a voice recognition system collides with an object or the like and is reflected thereby, and then is re-input to a microphone. The signal output from the loudspeaker is mixed with a voice signal of a user, which can cause a malfunction in voice recognition.

Since correlation between signals that are simultaneously output from multiple speakers of a video phone calling system or a voice recognition system is high, a multi-channel echo filter does not converge but diverges, and thus a malfunction in the systems or distortion in sound quality occurs.

Accordingly, a multi-channel de-correlation technique of reducing correlation between signals output from multiple speakers is required.

However, according to the de-correlation technology in the related art, a signal is mixed with a broadcasting signal or the broadcasting signal is deformed in order to reduce correlation between broadcasting signals of multiple channels.

Thus, according to the related art de-correlation technology, a phase of a broadcasting signal may become deformed according to frequencies or noise may become mixed in with the broadcasting signal, and the user may experience distorted sound quality.

### SUMMARY OF THE INVENTION

Exemplary embodiments provide a method and apparatus for processing multi-channel de-correlation, in which multi-channel acoustic echo components re-input to a microphone are canceled by reducing correlations between multiple channels.

According to an aspect of an exemplary embodiment, there is provided a method of processing multi-channel de-correlation, the method comprising: dividing an input multi-channel audio signal into units of frames to form multi-channel audio signals in units of frames; analyzing eigen values and eigen vectors related to the multi-channel audio signals by using the multi-channel audio signals in units of frames every time contents are modified; and separating the multi-channel audio signals in units of frames into a plurality of signal component spaces by using the analyzed eigen values and eigen vectors.

The dividing an input multi-channel audio signal into units of frames to form multi-channel audio signals in units of frames may further comprise calculating an energy of the multi-channel audio signal of the generated predetermined frames, and selecting an audio signal of an obtained frame having an energy equal to or greater than a predetermined reference value.

The analyzing of the eigen values and eigen vectors may comprise calculating eigen values and eigen vectors by using an audio signal having an energy equal to or greater than a predetermined reference value.

The eigen values and eigen vectors may be calculated by performing eigen-value decomposition.

The analyzing of the eigen values and eigen vectors may comprise: calculating a covariance matrix representing a correlation between channels of an input signal; and calculating the covariance matrix as an eigen vector matrix including eigen vectors and as an eigen value matrix including eigen values by using eigen value decomposition.

In the separating of the multi-channel audio signals in units of frames into a plurality of signal component spaces, when the contents are modified, eigen values and eigen vectors of the modified contents may be obtained by using a multi-channel audio signal of the predetermined frame units, and if the contents are not modified, previous eigen values and previous eigen vectors may be used to separate the multi-channel audio signals in units of frames into a plurality of signal component spaces.

According to an aspect of another exemplary embodiment, there is provided a multi-channel de-correlation processing apparatus comprising: a windowing unit dividing an input multi-channel audio signal into units of frames to form multi-channel audio signals in units of frames; a component space analyzing unit analyzing a plurality of signal component spaces from the multi-channel audio signals in units of frames every time contents are modified; and a projection unit projecting the plurality of signal component spaces to the multi-channel audio signals to separate the multi-channel audio signals into a plurality of signal component spaces.

According to an aspect of another exemplary embodiment, there is provided an apparatus for cancelling multi-channel acoustic echo, the apparatus comprising: a de-correlation processing unit converting a multi-channel audio signal in units of predetermined frames into a de-correlated signal between channels, which is separated into a plurality of signal component spaces by using a de-correlation matrix; and an echo cancelling unit cancelling an echo component of a signal picked up by a microphone by using the de-correlation signal between channels which was converted by the de-correlation processing unit.

### BRIEF DESCRIPTION OF THE DRAWINGS

The above and other aspects will become more apparent by describing in detail exemplary embodiments with reference to the attached drawings in which:

FIG. 1 is a block diagram illustrating a multi-channel de-correlation processing apparatus according to an exemplary embodiment;

FIG. 2 is a block diagram of a windowing unit of FIG. 1 according to an exemplary embodiment;

FIG. 3 is a block diagram of a component space analyzing unit of FIG. 1 according to an exemplary embodiment;

FIG. 4 is a flowchart illustrating a method of processing multi-channel de-correlation according to an exemplary embodiment;

FIG. 5 illustrates a frame signal generated according to the method of FIG. 4 according to an exemplary embodiment;

FIG. 6 is a schematic view of a signal component space obtained from the frame signal of FIG. 4;

FIG. 7 is a block circuit diagram illustrating a voice recognition system using a multi-channel de-correlation processing apparatus according to an exemplary embodiment; and

FIG. 8 is a block circuit diagram illustrating a calling system using a multi-channel de-correlation apparatus according to an exemplary embodiment.

### DETAILED DESCRIPTION OF THE INVENTION

Hereinafter, exemplary embodiments will be described with reference to the attached drawings. Expressions such as “at least one of,” when preceding a list of elements, modify the entire list of elements and do not modify the individual elements of the list. As used herein, the term “unit” means a hardware processor or general purpose computer implementing the associated operations.

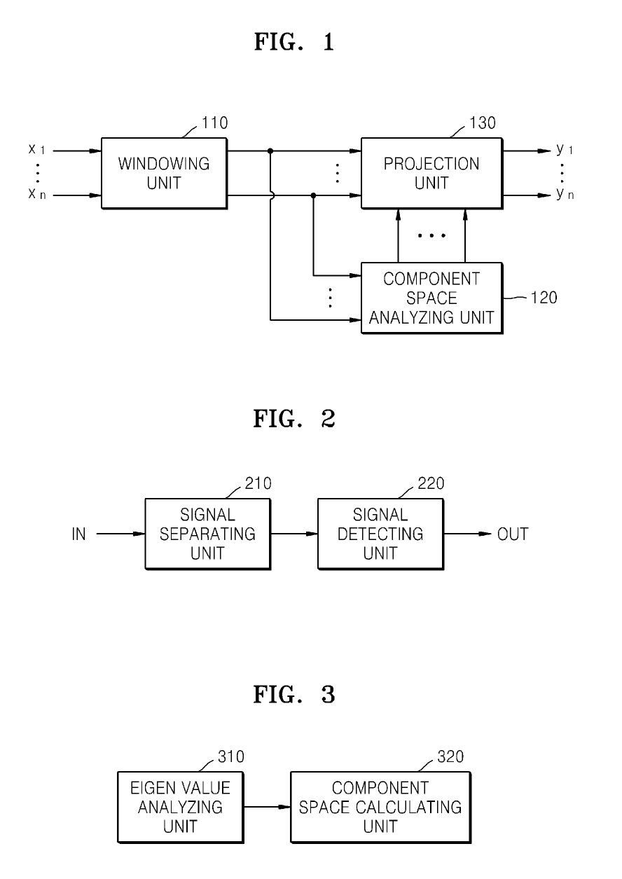

FIG. 1 is a block diagram illustrating a multi-channel de-correlation processing apparatus according to an exemplary embodiment.

The multi-channel de-correlation processing apparatus of FIG. 1 includes a windowing unit 110, a component space analyzing unit 120, and a projection unit 130. As understood by those in the art, these units of the multi-channel de-correlation processing apparatus may be embodied as processor or general purpose computer executing the associated functions and operations.

The windowing unit 110 receives multi-channel audio signals x1 through xn and divides the multi-channel audio signals x1 through xn into predetermined units of frames. According to the current exemplary embodiment, a predetermined frame unit may be 30 ms. The windowing unit 110 divides a multi-channel input signal into units of frames to generate frame signals.

According to the current exemplary embodiment, the windowing unit 110 may calculate energy of the frame signals and select frame signals having an energy equal to or greater than a predetermined reference value.

Every time contents are modified, the component space analyzing unit 120 analyzes a plurality of signal component spaces from the multi-channel audio signals in units of the predetermined frames, generated by using the windowing unit 110. For example, the plurality of signal component spaces may be voice component spaces or music component spaces included in multi-channel audio signals.

The projection unit 130 may project the plurality of signal component spaces analyzed by the component space analyzing unit 120 to the multi-channel audio signals in units of the predetermined frames, thereby separating the multi-channel audio signals into a plurality of signal component spaces.

Consequently, the projection unit 130 separates the multi-channel audio signals in units of the predetermined frames into a plurality of signal component spaces to thereby convert correlated multi-channel audio signals into de-correlated multi-channel audio signals y1 through yn which are output.

FIG. 2 is a block diagram of the windowing unit 110 of FIG. 1 according to an exemplary embodiment.

The windowing unit 110 includes a signal separating unit 210 and a signal detecting unit 220.

The signal separating unit 210 divides a multi-channel audio signal IN into units of predetermined frames, thereby generating a frame signal.

The signal detecting unit 220 compares energy of the frame signal generated by the signal separating unit 210 with a reference value, and detects a frame signal OUT having an energy equal to or greater than the reference value. For example, for an i-th frame signal being Xi(t), the signal detecting unit 220 calculates ∥Xi(t)∥2, and determines whether ∥Xi(t)∥2 is equal to or greater than a previously set reference value. If ∥Xi(t)∥2 is equal to or greater than the previously set reference value, a frame signal Xi(t) is output to the component space analyzing unit 120.

If a frame signal has energy less than the reference value, the frame signal may be determined as silent, and signal processing of the frame signal may be omitted.

FIG. 3 is a block diagram of the component space analyzing unit 120 of FIG. 1 according to an exemplary embodiment.

The component space analyzing unit 120 includes an eigen value analyzing unit 310 and a component space calculating unit 320.

The eigen value analyzing unit 310 analyzes eigen values and eigen vectors by using a multi-channel audio signal in units of predetermined frames. The eigen values and eigen vectors denote sizes of respective component spaces and directions of the component spaces.

The component space calculating unit 320 calculates a plurality of signal component spaces according to the eigen values and eigen vectors analyzed by the eigen value analyzing unit 310.

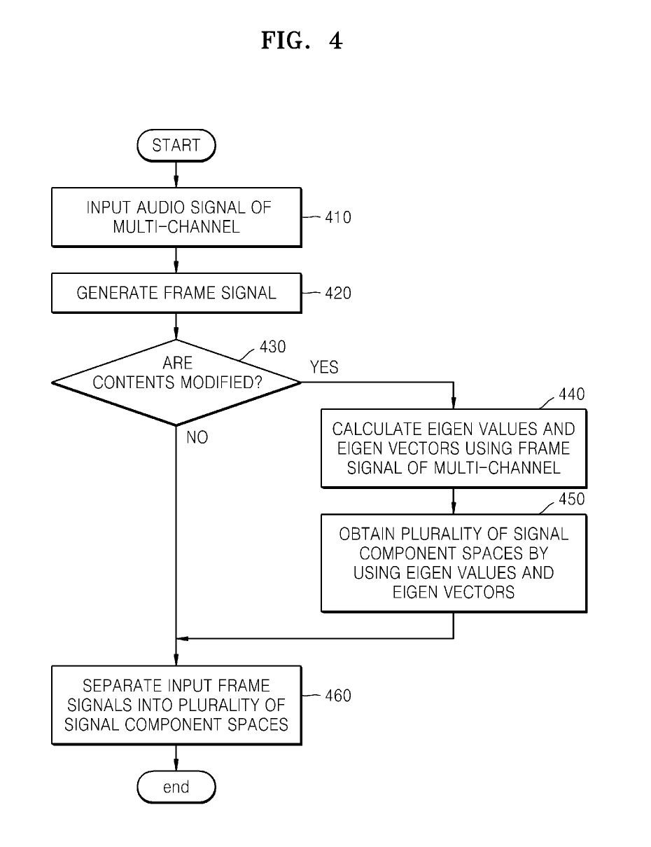

FIG. 4 is a flowchart illustrating a method of processing multi-channel de-correlation according to an exemplary embodiment.

In operation 410, multi-channel audio signals x1 through xn to be output through a loudspeaker are input.

In operation 420, the multi-channel audio signals x1 through xn are divided into units of predetermined frames to generate multi-channel audio signals in units of frames.

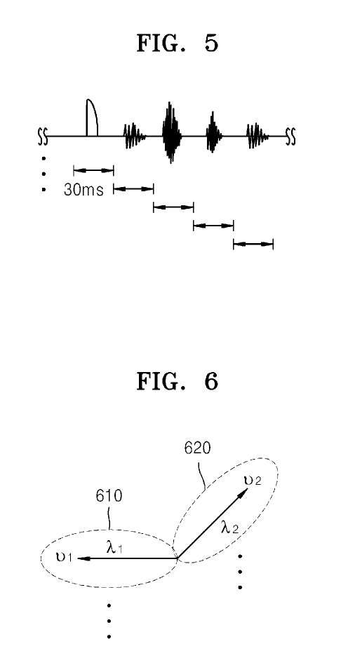

FIG. 5 illustrates a frame signal generated according to the method of FIG. 4 according to an exemplary embodiment. Referring to FIG. 5, a multi-channel audio signal may be divided in frame units of 30 ms. In addition, energy of frame signals may be calculated, and then only frame signals having energy equal to or greater than a predetermined reference value may be selected.

Next, in operation 430, to calculate signal component spaces of multi-channel audio signals every time contents are modified, it is checked whether or not contents are modified. For example, when a television (TV) channel or program is changed, a microprocessor (not shown) generates a control signal representing the change of contents.

If contents are modified, eigen vectors and eigen values are calculated by using input multi-channel audio signals in units of predetermined frames in operation 440. For example, as illustrated in FIG. 5, five frames of multi-channel audio signals (30 ms−5=150 ms) may be used, but exemplary embodiments are not limited thereto.

Also, the eigen vectors and eigen values denote space size and space direction, and are calculated by using Eigen-Value Decomposition (EVD), but exemplary embodiments are not limited thereto.

Hereinafter, an example of calculating eigen vectors and eigen values by EVD will be described.

First, a covariance matrix Rxx of an input signal is calculated. A covariance matrix represents a correlation value between channels.

The covariance matrix Rxx may be expressed as in Equation 1 below.

$${R}_{xx} = [ \begin{matrix}{x}_{1} {x}_{1} & … & {x}_{1} {x}_{n} \\ {x}_{2} {x}_{1} & … & {x}_{2} {x}_{n} \\ {x}_{n} {x}_{1} & … & {x}_{n} {x}_{n}\end{matrix} ] \qquad [ Equation 1 ]$$

Then, the covariance matrix Rxx may be represented by an eigen vector matrix including eigen vectors and an eigen value matrix including eigen values by using EVD as expressed in Equation 2.

$${R}_{xx} = {V}_{x} {Λ}_{x} {V}_{x}^{T} \\ {Λ}_{x} = [ \begin{matrix} {λ}_{1 } & 0 & … & 0 \\ 0 & {λ}_{2} & … & 0 \\ ⋮ & & & \\ …0 & 0 & … & {λ}_{n}\end{matrix} ] \\ {V}_{x} = [ \begin{matrix}{v}_{1} & {v}_{2} & … & {v}_{n}\end{matrix} ] \qquad [ Equation 2 ]$$

Vₓ^{T} is a transposed matrix of Vx.

Here, x denotes an input signal, and λ denotes an eigen value, and v denotes an eigen vector.

In operation 450, a plurality of signal component spaces are obtained from the frame signals according to the eigen vectors and the eigen values.

FIG. 6 is a schematic view of a signal component space obtained from the frame signal of FIG. 4. As illustrated in FIG. 6, for example, the frame signal is calculated as a first component space 610 (λ1, v1), a second component space 620 (λ2,v2), . . . and an n-th component space having eigen values λ and eigen vectors v. Vectors v of the component spaces are perpendicular to each other. In addition, the number of component spaces may preferably be determined according to the number of channels.

The plurality of component spaces are expressed as a de-correlation matrix W representing de-correlated signals between channels as shown in Equation 3 below.

W=Λₓ^{-1/2}Vₓ^{T} [Equation 3]

Next, in operation 460, input multi-channel audio signals in units of predetermined frames are separated into a plurality of signal component spaces by projecting the plurality of component spaces to the input multi-channel audio signals. For example, the signal component spaces may be voice component space, music component space, or broadcasting component space.

Here, frame signals that are separated into a plurality of component spaces correspond to de-correlated signals.

That is, an output multi-channel audio signal y is represented as in Equation 4.

y=Wₓ [Equation 4]

If contents are not modified, the multi-channel audio signals in units of predetermined frames are separated into a plurality of signal component spaces by projecting the signal component spaces that are obtained before contents are modified, into the multi-channel audio signals.

Consequently, according to the current exemplary embodiment, an input signal is converted into a de-correlated signal by converting a correlation matrix between channels of an input signal into a de-correlation matrix between channels, without mixing a signal with the input signal or deforming a phase of a frequency component of the input signal.

In particular, according to the exemplary embodiments, de-correlation is performed before acoustic echo cancellation (AEC) is performed, and thus there is no need to control a broadcasting signal of a digital TV (DTV), and an output sound of a loudspeaker is output without any deformation, and thus sound quality is not distorted.

In addition, according to the exemplary embodiments, by allowing a small degree of de-correlation with respect to signals of little similarity between channels, and a large degree of de-correlation with respect to signals of large similarly between channels, adaptive de-correlation is conducted.

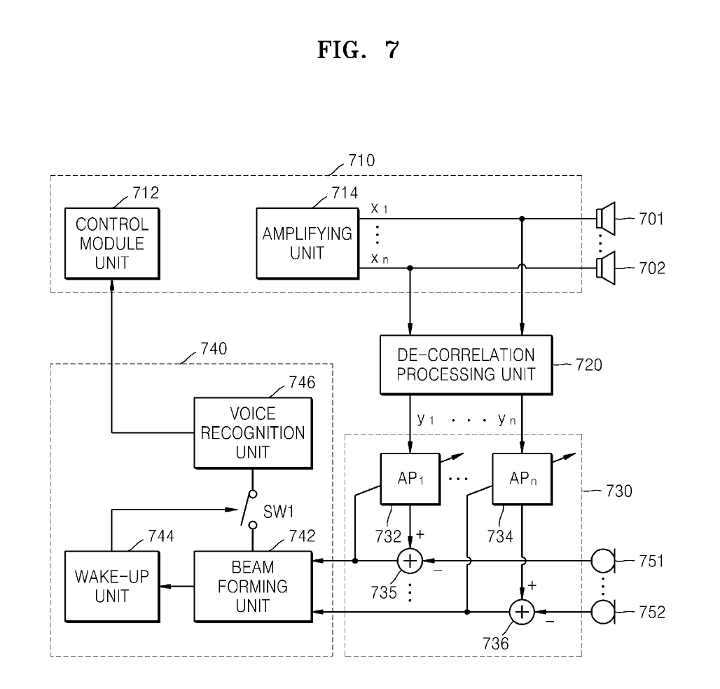

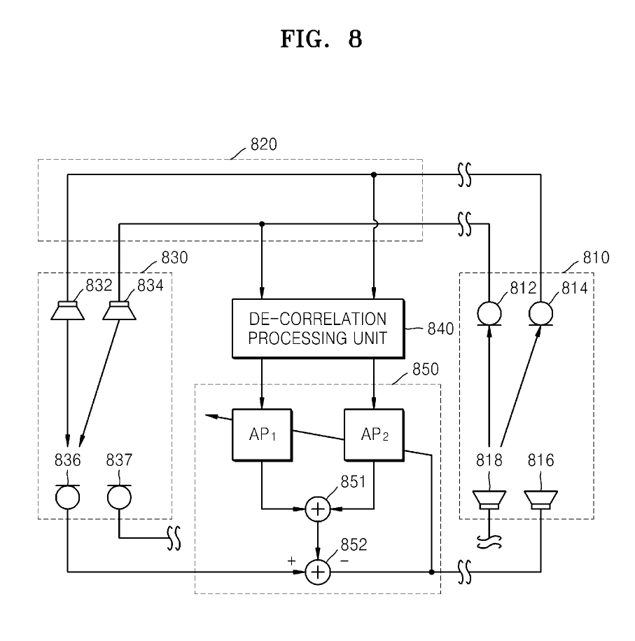

FIG. 7 is a block circuit diagram illustrating a voice recognition system using a multi-channel de-correlation apparatus according to an exemplary embodiment. As understood by those in the art, the units of the multi-channel de-correlation apparatus may be embodied as processor or general purpose computer executing the associated functions and operations.

The voice recognition system includes a signal processor 710, a de-correlation processing unit 720, an acoustic echo cancelling unit 730, and a voice recognition processing unit 740.

The signal processor 710 controls various operating functions and processes multi-channel audio signals and outputs the same. For easier understanding, only a control module 712 and an amplifying unit 714 of the signal processor 710 are illustrated.

The amplifying unit 714 amplifies multi-channel audio signals x1 through xn and outputs the same to speakers 701 and 702 of multi-channels.

The multi-channel audio signals x1 through xn output from the amplifying unit 714 are transmitted to the speakers 701 and 702 without any change, and are also transmitted to the de-correlation processing unit 720 at the same time.

The de-correlation processing unit 720 separates the input multi-channel audio signals x1 through xn into a plurality of signal component spaces and outputs de-correlated multi-channel audio signals y1 through yn. The de-correlation processing unit 720 operates in the same manner as the multi-channel de-correlation processing apparatus of FIG. 1, and thus a description thereof will be omitted here.

The echo cancelling unit 730 cancels multi-channel echo components that are re-input to a plurality of microphones 751 and 752 by using the de-correlated multi-channel audio signals y1 through yn that are de-correlated by the de-correlation processing unit 720, and detects only a voice signal of a talker.

The echo cancelling unit 730 will now be described in further detail. The de-correlated audio signals of n channels that are output from the de-correlation processing unit 720 are filtered using n adaptive filters AP1 through APn 732 through 734. That is, the n adaptive filters AP1 through APn 732 through 734 estimate output signals of speakers that are picked up by n microphones 751 and 752 by using the de-correlated multi-channel audio signals and output signals of subtracting units (signals from which a previous echo is cancelled). The estimated output signals correspond to an echo signal.

The de-correlated audio signals of n channels that are filtered using the n adaptive filters AP1 through APn 732 and 734 are subtracted from signals of the n microphones 751 and 752 in the subtracting units 735 and 736. In other words, the subtracting units 735 and 736 subtract the extracted echo signal from a signal picked up by the microphone to thereby extract only a voice signal of a talker.

The voice recognition processing unit 740 performs voice recognition by using a voice signal, from which an echo component is cancelled in the echo canceling unit 730. The voice recognition processing unit 740 includes a beam forming unit 742, a wake-up unit 744, and a voice recognition unit 746.

In detail, the beam forming unit 742 performs beam forming to remove noise except for noise in a set direction, from the voice signal, from which an echo is removed by the echo cancelling unit 730.

The wake-up unit 744 extracts a set command keyword from the voice signal on which beam forming is performed, to generate a voice recognition-On signal. The wake-up unit 744 outputs a voice recognition-On signal only when there is a set command keyword in the voice signal on which beam forming is performed. A switch SW1 activates or deactivates the voice recognition unit 746 by using an on/off signal generated in the wake-up unit 744.

The voice recognition unit 746 recognizes a command keyword output from the beam forming unit 742 according to the on/off signal of the wake-up unit 744.

The control module unit 712 controls various operating functions according to a command recognized by using the voice recognition unit 746.

Accordingly, according to the current exemplary embodiment, a signal output from the amplifying unit 714 is transmitted to the speakers 701 and 702 without any change and without distortion, and are de-correlated between channels at the same time in a front end of the echo cancelling unit 730 by pre-processing.

FIG. 8 is a block diagram illustrating a calling system using a multi-channel de-correlation apparatus according to an exemplary embodiment. As understood by those in the art, these units of the multi-channel de-correlation apparatus may be embodied as processor or general purpose computer executing the associated functions and operations.

The system includes a transmission space 810, a signal processing module 820, a reception space 830, a de-correlation processing unit 840, and an echo cancelling unit 850.

First, the transmission space 810 receives a voice of a talker via two microphones 812 and 814, and outputs the received voice of the talker to two speakers 832 and 834 of the reception space 830 via the signal processing module 820. The signal processing module 820 is omitted but is expressed by a line in FIG. 8 to facilitate easier understanding of an operation thereof.

The de-correlation processing unit 840 performs de-correlation by separating audio signals of two channels into at least one signal component space. The de-correlation processing unit 840 operates in the same manner as the multi-channel de-correlation apparatus of FIG. 1, and thus a description thereof will be omitted here.

The echo cancelling unit 850 cancels an echo component that is re-input to the two microphones 812 and 814 by using two channel audio signals that are de-correlated by using the de-correlation processing unit 840 and outputs only a voice signal of the talker.

In detail, de-correlated signals of first and second channels which are output from the de-correlation processing unit 840 are filtered through adaptive filters AP1 and AP2. In other words, the two adaptive filters AP1 and AP2 estimate output signals picked up by the two microphones 812 and 814 by using audio signals of two, de-correlated channels and an output signal of a subtracting unit 852 (a signal from which a previous echo is removed). The estimated output signal corresponds to an echo signal.

The echo signal extracted from the two adaptive filters AP1 and AP2 are added up in an adder 851. The subtracting unit 852 subtracts an echo signal and signals of the two microphones 836 and 837 to extract a voice signal of a talker only.

Finally, a voice signal extracted from the subtracting unit 852 is transmitted to the speakers 816 and 818 of the transmission space 810.

Accordingly, according to the current exemplary embodiment, a signal output from the transmission room 810 is transmitted to the speakers 832 and 834 without distortion, and is de-correlated between channels at the same time in a front end of the echo cancelling unit 730 by pre-processing.

The exemplary embodiments can be implemented as computer programs and can be implemented in general-use digital computers or processors that execute the programs stored in a computer readable recording medium. Examples of the computer readable recording medium include read-only memory (ROM), random-access memory (RAM), CD-ROMs, magnetic tapes, floppy disks, optical data storage devices, etc.

While exemplary embodiments have been particularly shown and described, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the inventive concept is defined not by the detailed description of the invention but by the appended claims, and all differences within the scope will be construed as being included in the inventive concept.

What is claimed is:

1. A method of processing multi-channel de-correlation, the method comprising:
dividing an input multi-channel audio signal into units of frames to form multi-channel audio signals in units of the frames;
analyzing eigen values and eigen vectors related to the multi-channel audio signals by using the multi-channel audio signals in units of the frames when contents are modified; and
separating the multi-channel audio signals in units of the frames into a plurality of signal component spaces by using the analyzed eigen values and the analyzed eigen vectors.

2. The method of claim 1, wherein the dividing the input multi-channel audio signal into units of the frames to form the multi-channel audio signals in units of the frames further comprises calculating an energy of the multi-channel audio signals in units of frames, and selecting an audio signal of a frame having an energy equal to or greater than a reference value.

3. The method of claim 1, wherein the analyzing the eigen values and the eigen vectors comprises calculating eigen values and eigen vectors by using an audio signal having an energy equal to or greater than a reference value.

4. The method of claim 3, wherein the eigen values and eigen vectors are calculated by performing eigen-value decomposition.

5. The method of claim 1, wherein the analyzing the eigen values and eigen vectors comprises:
calculating a covariance matrix representing a correlation between channels of an input signal; and
calculating the covariance matrix as an eigen vector matrix including eigen vectors and as an eigen value matrix including eigen values by using eigen value decomposition.

6. The method of claim 1, wherein in the separating the multi-channel audio signals in units of frames into the plurality of signal component spaces, when the contents are modified, eigen values and eigen vectors of the modified contents are obtained by using the multi-channel audio signals in units of the frames, and if the contents are not modified, previous eigen values and previous eigen vectors are used to separate the multi-channel audio signals in units of the frames into a plurality of signal component spaces.

7. A multi-channel de-correlation processing apparatus comprising:
a windowing unit that divides an input multi-channel audio signal into units of frames to form multi-channel audio signals in units of the frames;
a component space analyzing unit that analyzes a plurality of signal component spaces from the multi-channel audio signals in units of the frames when contents are modified; and
a projection unit that projects the plurality of signal component spaces to the multi-channel audio signals to separate the multi-channel audio signals into a plurality of signal component spaces.

8. The multi-channel de-correlation processing apparatus of claim 7, wherein the windowing unit comprises:
a signal separating unit that generates a frame signal by separating an input signal into signals in units of the frames; and
a signal detecting unit that compares an energy of the frame signal generated by the signal separating unit, with a reference value, and detects a frame signal having an energy equal to or greater than a reference value.

9. The multi-channel de-correlation processing apparatus of claim 7, wherein the component space generating unit comprises:
an eigen value analyzing unit that analyzes eigen values and eigen vectors by using the multi-channel audio signals in units of the frames when contents are modified; and
a comment space calculating unit that calculates a plurality of signal component spaces according to the eigen values and the eigen vectors.

10. The multi-channel de-correlation processing apparatus of claim 9, wherein the eigen value analyzing unit uses an audio signal of a frame having an energy equal to or greater than a reference value.

11. An apparatus for cancelling multi-channel acoustic echo, the apparatus comprising:
a de-correlation processing unit that converts a multi-channel audio signal in units of frames into a de-correlated signal between channels, which is separated into a plurality of signal component spaces by using a de-correlation matrix; and
an echo cancelling unit that cancels an echo component of a signal picked up by a microphone by using the de-correlation signal between channels which was converted by the de-correlation processing unit.

12. The apparatus of claim 11, wherein the de-correlation processing unit comprises:
a windowing unit that divides an input multi-channel audio signal into units of frames to form multi-channel audio signals in units of the frames;
a component space analyzing unit that analyzes a plurality of signal component spaces from the multi-channel audio signals in units of the frames when contents are modified; and
a projection unit that projects the plurality of signal component spaces to the multi-channel audio signals to separate the multi-channel audio signals into a plurality of signal component spaces.

13. The apparatus of claim 11, wherein the echo cancelling unit comprises:
an adaptive filter unit that estimates an echo signal picked up by a plurality of microphones by using a de-correlated signal between channels and a signal, from which an echo component is cancelled; and
a subtracting unit that subtracts a signal picked up by a microphone from the estimated echo signal to extract a voice signal.

14. A computer readable recording medium having embodied thereon a program for executing the method of claim 1.
